(19) United States
(12) Patent Application Publication
(10) Pub. No.: US 2009/0304081 A1
(43) Pub. Date: Dec. 10, 2009

(54) CODING DEVICE AND METHOD FOR SCALABLE ENCODING OF MOVIE CONTAINING FIELDS

(75) Inventor: Arnaud Bourge, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/293,435

(22) PCT Filed: Mar. 16, 2007
(86) PCT No.: PCT/IB07/50913

§ 371 Date: Aug. 18, 2009

(30) Foreign Application Priority Data
Mar. 23, 2006 (EP) 06300277.8

(51) Int. Cl. H04N 7/32

(52) U.S. Cl. 375/240.15; 375/E07.243

(57) ABSTRACT

A coding device (D1), for an electronic equipment, comprises coding means (CM) for encoding movie data into a compressed scalable bitstream (SVB), starting from at least one interlaced base layer (BL) comprising interlaced fields, amongst which some are duplicated fields associated to a field repeat flag, and at least one progressive enhancement layer (EL) comprising progressive frames. These coding means are more precisely arranged i) to constitute a prediction layer (PL) comprising prediction frames defined from first and second fields of the interlaced base layer (BL), except those containing a duplicated field, and ii) to encode the progressive frames of each progressive enhancement layer (EL) by computing the difference between each prediction frame and the corresponding progressive frame, while taking into account the field repeat flags associated to the corresponding duplicated fields of the interlaced base layer (BL), in order to handle the missing prediction frames.

### FIELD OF THE INVENTION

The present invention relates to the domain of video compression/decompression, and more precisely to video applications involving scalable video bit-stream. More specifically, the invention relates to a coding device comprising coding means for encoding movie data into a compressed scalable bitstream, starting from at least one interlaced base layer comprising interlaced fields, amongst which some are duplicated fields associated to a field repeat flag, and at least one progressive enhancement layer comprising progressive frames.

### BACKGROUND OF THE INVENTION

Examples of scalable video compression techniques adapted to output scalable video bitstreams are notably described in the scalable extensions of the MPEG-2 standard (see for instance “Information Technology—Generic coding of moving pictures and associated audio information: Video, ISO/IEC 13818-2, 1996), in the scalable extensions of the MPEG-4 standard (see for instance “Information Technology—Coding of Audio-Visual Objects—Part 2: Visual”, ISO/IEC 14496-2:2001, Second Edition, 2001), and in the scalable extension of the H.264/AVC (also known as JSVC) standard (see for instance “Final Draft International Standard of Joint Video Specification”, ISO IEC 14496-10, 2004, and JSVC Working Draft 2, output document JVT-O201 of the 16^{th} JVT meeting, Busan, South Korea, April 2005).

The scalable video encoding is used in a lot of applications such as in-home networking, xDSL broadcasting and mobile streaming. Some of these applications are notably described in the document “Requirements and Applications for Scalable Video Coding”, output document N6880 of the 71^{st} MPEG meeting, Hong Kong, China, January 2005.

Some of these applications concern movies (progressive scanning at 24 frames per second) which are streamed or broadcasted to a variety of devices, such as standard definition (interlaced) or high definition (progressive) television sets. In such applications, the movie data that has to be encoded comprises at least one base layer and at least one enhancement layer. The base layer(s) (or at least one of the lower spatial layers) is (are) preferably encoded with interlaced fields, and the enhancement layer(s) allow(s) retrieving the progressive signal, while the frame rate always has to match the one of the targeted display. The invention relates to such kind of scalable video bit-streams.

These movies (or films) are also temporally different from videos because of their different frame rates. It is recalled that video rates vary according to the standards, for instance 30 frames per second in NTSC, 25 frames per second in PAL/SECAM, and 25, 30 or 60 frames per second in case of high definition (HD).

Because of this temporal difference, movies (or films) require a temporal adjustment before being encoded and transmitted on television, for instance. To apply this temporal adjustment one can use for instance the so-called “3:2 pull-down” technique, which aims at converting a film signal into an interlaced video signal at 30 frames, or 60 fields, per second. Some temporal adjustment techniques, especially with this 3:2 pull-down technique, introduce some data field duplications. In order to efficiently encode the duplicated data fields of the base layer, a so-called “field repeat flag” is then used in existing video compression standards.

If one wants to encode such a sequence in a scalable fashion with a progressive enhancement layer using existing techniques (such as the compression standards quoted above), there are at least three solutions.

A first solution consists in encoding the enhancement and base layers as if they were all progressive. With such a solution the base layer is however not well encoded.

A second solution consists in encoding the enhancement and base layers as if they were all interlaced, but with such a solution a “Field Picture encoding” penalizes the compression efficiency of the enhancement layer(s).

A third solution illustrated in FIG. 1 consists in encoding the base layer (BL) using interlaced coding tools and then in regrouping by pairs consecutive interlaced fields (FTi, BTi) of this encoded base layer (BL) into prediction frames (PFr) that are used to predict the enhancement (upper) layer(s) (EL). However, such a solution generates some (mismatched) prediction frames (MPFr) which are the combination of two fields (FTi, BTi) belonging to different frames in the original material, and which are very bad for the prediction.

Encoding a scalable video stream comprising duplicated fields or frames is therefore possible with the above cited compression techniques (such as MPEG-2, MPEG-4 and H.264/AVC), but it appears that this is not efficient in terms of compression performance and visual quality.

### SUMMARY OF THE INVENTION

The object of this invention is to improve this situation.

To this end, the invention relates to a coding device such as defined in the introductory part of the description and which is moreover characterized in that the coding means are arranged i) to constitute a prediction layer comprising prediction frames defined from pairs of fields of the interlaced base layer, except those containing a duplicated field, and ii) to (en)code the progressive frames of the progressive enhancement layer(s) by computing the difference between each prediction frame and the corresponding progressive frame, while taking into account the field repeat flags associated to the corresponding duplicated fields of the interlaced base layer in order to handle the missing prediction frames.

In other words, one uses the field repeat flags associated to the duplicated fields of the interlaced base (or lower) layer in order to encode the progressive frames of one or more progressive enhancement (or upper) layer(s) associated to this interlaced base layer. This allows a more efficient coding and a better reconstruction of the progressive video sequence during decoding.

The coding device according to the invention may include additional characteristics considered separately or combined, and notably:

(a) the coding means may be arranged i) to constitute a prediction layer comprising only prediction frames defined from pairs of fields of an interlaced base layer that are not associated to a field repeat flag, and ii) to only (en)code each progressive frame which corresponds to a prediction frame, by computing the difference between this progressive frame and the corresponding prediction frame;

(b) the coding means may be arranged i) to constitute a prediction layer comprising prediction frames defined from pairs of fields of an interlaced base layer that are not associated to a field repeat flag, and duplicated prediction frames each identical to the preceding prediction frame when it corresponds to a field of this interlaced base layer associated to a field repeat flag, and ii) to (en)code the progressive frames by computing the difference between themselves and the corresponding prediction frames and duplicated prediction frames;

(c) the coding means may be arranged i) to constitute a prediction layer comprising prediction frames defined from pairs of fields of an interlaced base layer that are not associated to a field repeat flag, and for filling up each missing prediction frame corresponding to a field of the interlaced base layer that is associated to a field repeat flag, with the duplicate of the progressive frame which precedes the progressive frame corresponding to this missing prediction frame, and ii) to (en)code each progressive frame which corresponds to a prediction frame, by computing the difference between this progressive frame and the corresponding prediction frame or duplicate of a progressive frame;

(d) the coding device may comprise spatial over-sampling means arranged for applying a spatial over-sampling to the prediction layer, in order to get a spatial resolution identical to the one of the progressive frames to encode;

(e) the coding device may comprise adjustment means for applying a temporal adjustment technique to primary movie data associated to a first frame rate, in order to output the interlaced base layer(s) and the progressive enhancement layer(s) with a second frame rate adapted to display on a chosen display device (for instance, the adjustment means may be arranged to apply the so-called “3:2 pull-down” temporal adjustment technique).

The invention also provides a decoding device comprising decoding means for decoding a compressed scalable bitstream, starting from at least one encoded interlaced base layer comprising interlaced encoded fields, amongst which some are duplicated fields associated to a field repeat flag, and at least one encoded progressive enhancement layer comprising encoded progressive frames.

This decoding device is characterized in that the decoding means are arranged i) to constitute a prediction layer comprising prediction frames defined from pairs of fields of the encoded interlaced base layer, and ii) to rebuild the progressive frames of the progressive enhancement layer(s) by computing the sum of each prediction frame and the corresponding encoded progressive frame of each encoded progressive enhancement layer, while taking into account the field repeat flags associated to the corresponding duplicated fields of the encoded interlaced base layer.

The decoding device according to the invention may include additional characteristics considered separately or combined, and notably:

(a) the decoding means may be arranged i) to constitute a prediction layer comprising only prediction frames defined from pairs of fields of the encoded interlaced base layer that are not associated to a field repeat flag, and ii) to rebuild each progressive frame of the progressive enhancement layer(s) by computing the sum of each prediction frame and the corresponding encoded progressive frame, and, for filling up each missing progressive frame corresponding to a field of the encoded interlaced base layer that is associated to a field repeat flag, with the duplicate of the preceding rebuilt progressive frame;

(b) the decoding means may be arranged i) to constitute a prediction layer comprising prediction frames defined from pairs of fields of the encoded interlaced base layer that are not associated to a field repeat flag, and duplicated prediction frames each identical to the preceding prediction frame when it corresponds to a field of this encoded interlaced base layer associated to a field repeat flag, and ii) to rebuild each progressive frame of the progressive enhancement layer(s) by computing the sum of each prediction frame or duplicated prediction frame and the corresponding encoded progressive frame;

(c) the decoding means may be arranged i) to constitute a prediction layer comprising only prediction frames defined from pairs of fields of the encoded interlaced base layer that are not associated to a field repeat flag, and ii) to rebuild each progressive frame of the progressive enhancement layer(s) corresponding to a prediction frame by computing the sum of this prediction frame and the corresponding encoded progressive frame, and to rebuild each progressive frame of the progressive enhancement layer(s) corresponding to a missing prediction frame by computing the sum of the corresponding encoded progressive frame and the duplicate of the rebuilt progressive frame which precedes this progressive frame to rebuild.

The invention also provides electronic equipment comprising a coding device and/or a decoding device such as the ones above introduced. Such electronic equipment may be a home server, or a set-top-box dedicated to in-home networking, or a broadcasting encoder, or a streaming encoder, or else a display set, for instance.

The invention also provides a method for encoding movie data in a compressed scalable bitstream, starting from at least one interlaced base layer comprising interlaced fields, amongst which some are duplicated fields associated to a field repeat flag, and at least one progressive enhancement layer comprising progressive frames.

This encoding method consists in i) constituting a prediction layer comprising prediction frames defined from pairs of fields of the interlaced base layer, and ii) encoding the progressive frames of each progressive enhancement layer by computing the difference between each prediction frame and the corresponding progressive frame, while taking into account the field repeat flags associated to the corresponding first and second duplicated fields of the interlaced base layer.

The invention also provides a method for decoding a compressed scalable bitstream, starting from at least one encoded interlaced base layer comprising interlaced encoded fields, amongst which some are duplicated fields associated to a field repeat flag, and at least one encoded progressive enhancement layer comprising encoded progressive frames.

This decoding method comprises the steps of i) constituting a prediction layer comprising prediction frames defined from pairs of fields of the encoded interlaced base layer, and ii) rebuilding the progressive frames of each progressive enhancement layer(s) by computing the sum of each prediction frame and the corresponding encoded progressive frame of each encoded progressive enhancement layer, while taking into account the field repeat flags associated to the corresponding first and second duplicated fields of the encoded interlaced base layer.

A typical application of the invention is the television broadcasting of movies to different electronic devices, such as interlaced standard definition display sets (which are interlaced cathodic tube displays in many cases) or progressive high definition display sets.

### BRIEF DESCRIPTION OF THE DRAWINGS

Other features and advantages of the invention will become apparent on examining the detailed specifications hereafter and the appended drawings, wherein:

FIG. 1 schematically illustrates an example of interlaced base layer (BL), progressive enhancement layer (EL) to encode, and prediction layer (PL), according to the state of the art,

FIG. 2 schematically and functionally illustrates an example of embodiment of a coding device according to the invention,

FIG. 3 schematically illustrates an example of interlaced base layer (BL) and progressive enhancement layer (EL) to encode, and a first example of corresponding prediction layer (PL) and encoded progressive enhancement layer (EL′),

FIG. 4 schematically illustrates an example of interlaced base layer (BL) and progressive enhancement layer (EL) to encode, and a second example of corresponding prediction layer (PL) and encoded progressive enhancement layer (EL′),

FIG. 5 schematically illustrates an example of interlaced base layer (BL) and progressive enhancement layer (EL) to encode, and a third example of corresponding prediction layer (PL) and encoded progressive enhancement layer (EL′),

FIG. 6 schematically and functionally illustrates an example of embodiment of a decoding device according to the invention,

FIG. 7 schematically illustrates an example of encoded interlaced base layer (BL′) and encoded progressive enhancement layer (EL′) to decode, and a first example of corresponding prediction layer (PL′) and decoded progressive enhancement layer (EL″),

FIG. 8 schematically illustrates an example of encoded interlaced base layer (BL′) and encoded progressive enhancement layer (EL′) to decode, and a second example of corresponding prediction layer (PL′) and decoded progressive enhancement layer (EL″), and

FIG. 9 schematically illustrates an example of encoded interlaced base layer (BL′) and encoded progressive enhancement layer (EL′) to decode, and a third example of corresponding prediction layer (PL′) and decoded progressive enhancement layer (EL″).

### DETAILED DESCRIPTION

Reference is initially made to FIG. 2, which describes an example of embodiment of a coding device D1 according to the invention, said coding device being for instance part of an electronic equipment such as a home server, or a set-top-box (especially if it is dedicated to in-home networking), or a broadcasting encoder, or else a streaming encoder. This invention is particularly well fitted to television broadcasting of movies (or films) to different electronic devices, such as interlaced standard definition display sets or progressive high definition display sets.

It is recalled that a movie (or film) has a frame rate which is different from the one of a video. A movie frame rate is generally equal to 24 frames (or images) per second. The video frame rate varies according to the standard (30 frames per second in NTSC, 25 frames per second in PAL/SECAM, and 25, 30 or 60 frames per second in case of high definition (HD)).

As schematically and functionally illustrated in FIG. 2, a coding device D1 according to the invention comprises at least a coding module CM for encoding received movie data into a compressed scalable bit-stream.

It is important to notice that the received movie data are either (pre-processed) data to which a temporal adjustment technique has been applied in order to convert their (first) frame rate into another (second) frame rate, or “primary” data PVD to which such a temporal adjustment technique has to be applied. In case where the received movie data are pre-processed data, the coding device D1 only comprises a coding module CM. In case where the received movie data are primary data PVD, the coding device D1 must comprise an adjustment module AM (for the frame rate conversion) and a coding module CM, as illustrated in FIG. 2.

Any temporal adjustment technique known by the man skilled in the art may be implemented (possibly by the adjustment module AM) to produce pre-processed movie data ready to be processed and encoded before being transmitted, for instance on television. For instance one may use the so-called “3:2 pull-down” technique, which converts a film signal into an interlaced video signal at 30 frames (or 60 fields) per second. One means here by “pre-processed movie data” movie data to which a temporal adjustment technique has been applied and which are shared out in at least one interlaced (movie data) base layer BL and at least one progressive (movie data) enhancement layer EL.

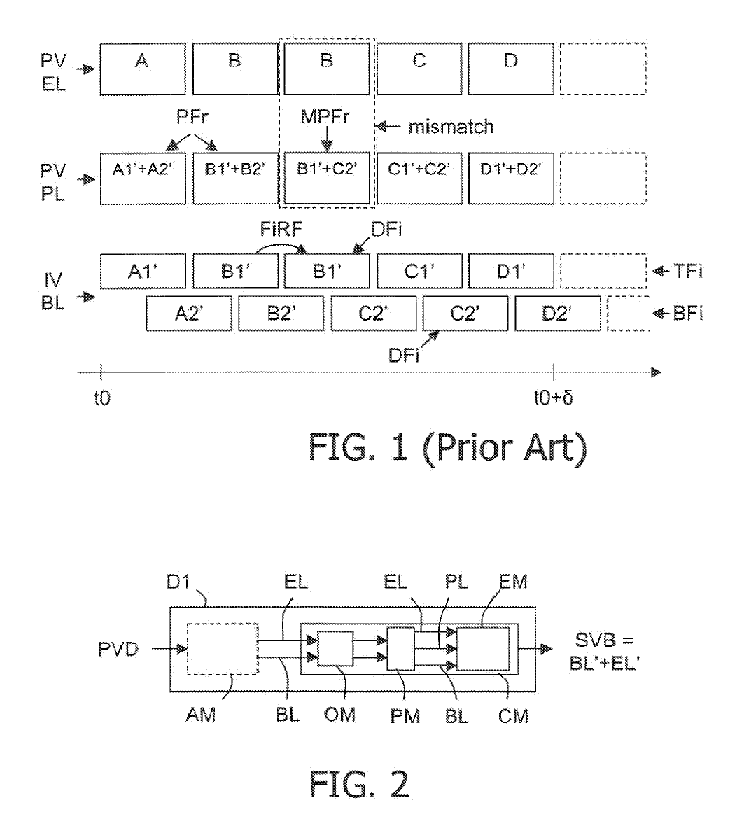

It is recalled that an interlaced base layer BL comprises interlaced data fields defining images at a low or standard resolution, while the progressive enhancement layer(s) EL comprise(s) progressive frames allowing a higher image resolution when they are combined with one or more associated interlaced base layer(s) during a display with progressive scanning. More precisely, an interlaced base layer BL comprises top fields TFi usually comprising data defining the odd (or even) lines of images, starting from the first one, and bottom fields BFi usually comprising data defining the even (or odd) lines of images. The top fields TFi are temporally shifted from the bottom fields BFi as illustrated in FIG. 1. The interlaced fields of all the images of a video define an “interlaced video” (IV).

Furthermore, a progressive enhancement layer EL comprises image data grouped into progressive frames. The progressive enhancement layer data are generally called “progressive data” and define what is generally called a “progressive video” (PV). One or more progressive enhancement layers may be associated to an interlaced base layer. The progressive data of the decoded progressive enhancement layer(s) are intended to be combined, before being displayed, with the decoded interlaced data of the associated decoded interlaced base layer in order to define a standard or high definition image.

It is assumed here that the interlaced base layer BL of the received movie data that has to be processed and encoded comprises some duplicated fields DF that have been introduced by the temporal adjustment technique. As it is known by the man skilled in the art, each duplicated field DF is associated with a flag generally named “field repeat flag” and transmitted in the encoded bitstream SVB.

The coding module CM may comprise a spatial over-sampling module intended for applying a spatial over-sampling to the first TFi and second BFi fields of the received pre-processed interlaced base layer BL before they are used to constitute a prediction layer PL. This allows to get an interlaced base layer BL with a spatial resolution identical to the one of the progressive frames to encode.

The coding module CM comprises a processing module PM arranged for constituting a prediction layer PL from the top TFi fields and bottom fields BFi of the received interlaced base layer BL. More precisely, it constitutes a prediction layer PL which comprises prediction frames PFr, each comprising a top field TFi of a base layer BL and the bottom field BFi (of this base layer BL), which is temporally located just after this top field TFi. For instance, if a base layer BL comprises the sequence of top fields TFi (A1′, B1′, B1′, C1′, D1′, . . . ) and the sequence of bottom fields BFi (A2′, B2′, C2′, C2′, D2′, . . . ), then the prediction layer PL should comprise the sequence of prediction frames (A1′+A2′, B1′+B2′, B1′+C2′, C1′+C2′, D1′+D2′, . . . ) illustrated in FIG. 1.

The prediction layer PL is used by an encoding sub-module EM of the coding module CM to encode the progressive frames of each progressive enhancement layer EL. More precisely, the encoding sub-module EM is arranged to compute the difference between each prediction frame of the prediction layer PL and the corresponding progressive frame of a progressive enhancement layer EL in order to output an encoded progressive enhancement layer EL′ comprising encoded progressive frames.

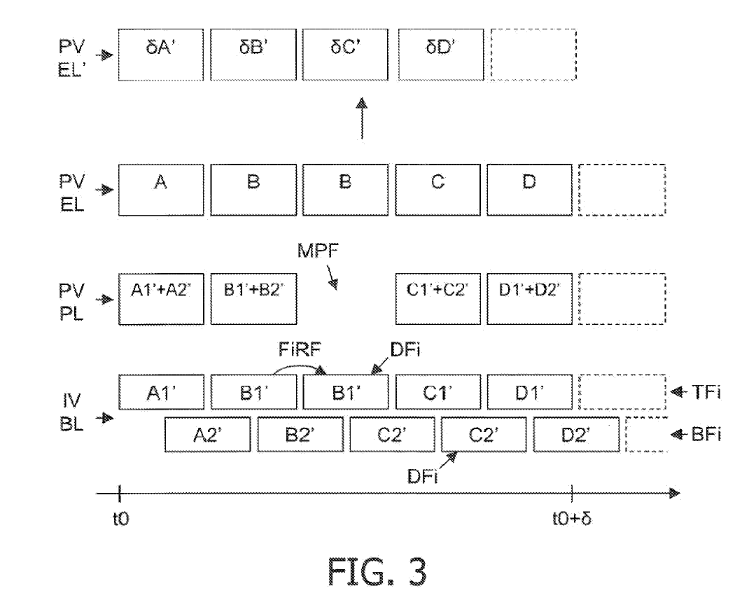

For instance, and as illustrated in FIG. 3, if a prediction frame is equal to A1′+A2′ and the corresponding progressive frame is equal to A, then the corresponding encoded progressive frame, computed by the encoding sub-module EM, is equal to δA′, with δA′=A−(A1′+A2′).

This kind of computation works correctly when the prediction layer PL comprises prediction frames constituted from top and bottom fields that belong to a same image. But it does not work correctly when the prediction layer PL comprises “composite” prediction frames (or mismatched prediction frames) MPFr constituted from top and bottom fields that belong to two consecutive images (as illustrated in FIG. 1). Such a situation occurs when the interlaced base layer BL comprises duplicated fields DFi. In this case there is a mismatch between the “composite” prediction frame MPFr and the corresponding progressive frame to encode. The third prediction frame (B1′+C2′) of the prediction layer PL of FIG. 1 is an example of such a composite prediction frame.

The coding device D1 according to the invention aims at overcoming the drawback introduced by the duplicated fields DFi of the interlaced base layer BL.

For this purpose, its processing module PM is arranged, when it receives pre-processed movie data (BL+EL), to constitute a prediction layer PL comprising prediction frames defined from first TFi and second BFi fields of the interlaced base layer BL, and its encoding sub-module EM is arranged to encode the progressive frames of each enhancement layer EL by computing the difference between each prediction frame and the corresponding progressive frame, while taking into account the field repeat flags FiRF which are associated to the corresponding first TFi and second BFi duplicated fields of the interlaced base layer BL.

The field repeat flags FiRF may be used in at least three different manners by the coding device D1.

Reference is now made to FIG. 3 to describe a first manner to use the field repeat flags FiRF during encoding, according to the invention. In said first manner, the processing module PM is arranged, each time it receives pre-processed movie data comprising at least an interlaced base layer BL associated with at least one enhancement layer EL, to constitute a prediction layer PL which comprises only prediction frames each defined from a top field TFi and a bottom field BFi of the interlaced base layer BL that are not associated to a field repeat flag FiRF. So, the processing module PM does not retain the composite prediction frames, and some prediction frames are missing (MPF) into the prediction layer PL.

In this case, the encoding sub-module EM is arranged to only encode each progressive frame of the progressive enhancement layer EL which corresponds to a prediction frame. So, it computes the difference between each progressive frame corresponding to an existing prediction frame and this corresponding prediction frame.

In the example illustrated in FIG. 3, the third prediction frame MPF is missing, so that the encoding sub-module EM does not encode the third progressive frame of the enhancement layer EL. Therefore the encoded progressive enhancement layer EL′ comprises encoded progressive frames δA′, δB′, δC′ and δD′ resulting from the respective differences (A−(A1′+A2′)), (B−(B1′+B2′)), (C−(C1′+C2′)) and (D−(D1′+D2′)).

It is important to notice that the encoding technique implemented by the encoding sub-module EM, according to the first manner (relative to FIG. 3), is identical to the one implemented by a coding device of the prior art, once the prediction layer PL has been constituted. This encoding technique being well known by the man skilled in the art, it will not be described here.

The encoding sub-module EM outputs a compressed scalable bitstream SVB, comprising the encoded interlaced base layer BL′ and the encoded progressive enhancement layer(s) EL, ready to be transmitted to display devices for instance through a network.

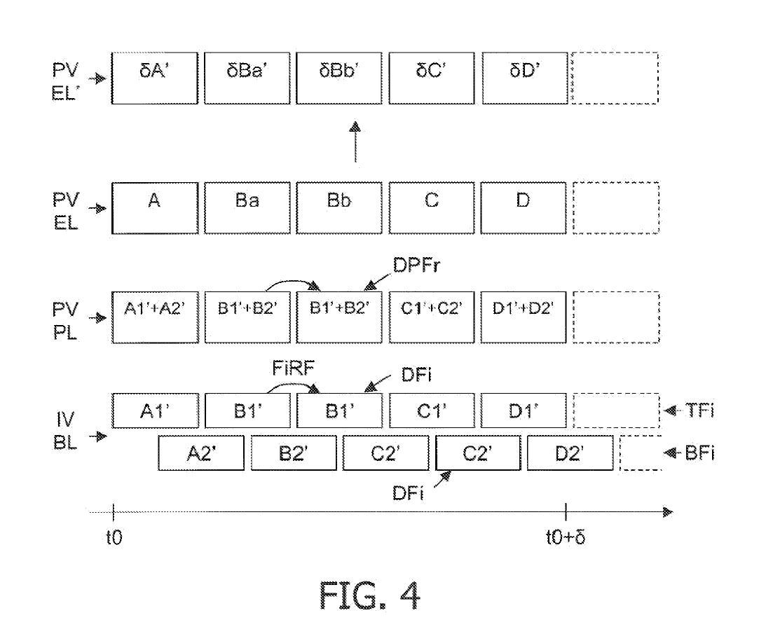

Reference is now made to FIG. 4 to describe a second manner to use the field repeat flags FiRF during encoding, according to the invention. In said second manner, the processing module PM is arranged, each time it receives pre-processed movie data comprising at least an interlaced base layer BL associated with at least one enhancement layer EL, to constitute a prediction layer PL which comprises prediction frames each defined from a top field TFi and a bottom field BFi of the interlaced base layer BL that are not associated to a field repeat flag FiRF, and duplicated prediction frames DPFr that are respectively identical to the prediction frames which precede them when they correspond to a first TFi and/or a second BFi field(s) of the interlaced base layer BL which is (are) associated to a field repeat flag (FiRF). So, there is neither composite prediction frame nor missing prediction frame MPF into the prediction layer PL.

In the non-limiting example of FIG. 4, the prediction layer PL comprises the sequence of prediction frames (A1′+A2′, B1′+B2′, B1′+B2′, C1′+C2′, D1′+D2′, . . . ). The third prediction frame (B1′+B2′) is a duplicate DPFr of the second prediction frame (B1′+B2′), because it corresponds to a duplicated field (B1′) DFi associated with a field repeat flag FiRF.

In this case, the encoding sub-module EM is arranged to encode each progressive frame of the progressive enhancement layer EL because they are all associated with a corresponding prediction frame or duplicated prediction frame DPFr. So, it computes the difference between each progressive frame and the corresponding prediction frame or duplicated prediction frame DPFr.

In the example illustrated in FIG. 4, the encoding sub-module EM produces an encoded progressive enhancement layer EL′ comprising encoded progressive frames δA′, δBa′, δBb′, δC′ and δD′ resulting from the respective differences (A−(A1′+A2′)), (Ba−(B1′+B2′)), (Bb−(B1′+B2′)), (C−(C1′+C2′)) and (D−(D1′+D2′)).

It is important to notice that the encoding technique implemented by the encoding sub-module EM, according to the second manner (relative to FIG. 4), is identical to the one implemented by a coding device of the prior art, once the prediction layer PL has been constituted. This encoding technique is well known by the man skilled in the art, and it will not be described here.

The encoding sub-module EM outputs a compressed scalable bitstream SVB, comprising the encoded interlaced base layer BL′ and the encoded progressive enhancement layer(s) EL, ready to be transmitted to display devices for instance through a network.

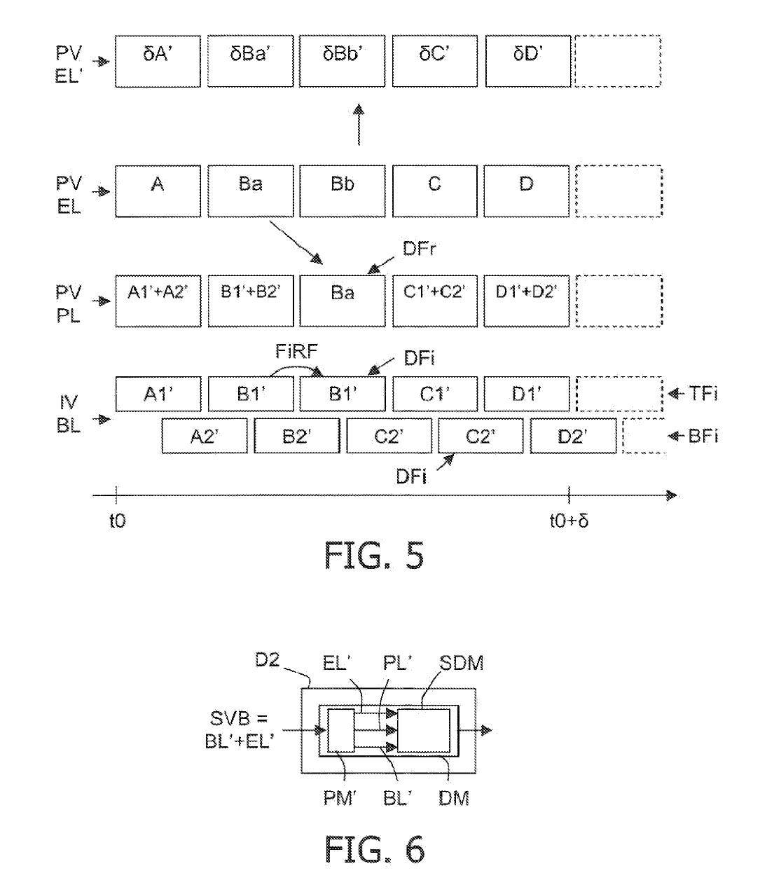

Reference is now made to FIG. 5 to describe a third manner to use the field repeat flags FiRF during encoding, according to the invention. In said third manner, which is a kind of variant of the first manner, the processing module PM is arranged, each time it receives pre-processed movie data comprising at least an interlaced base layer BL associated with at least one progressive enhancement layer EL, to constitute a prediction layer PL which comprises prediction frames of two sources.

The first source is the interlaced base layer BL. The processing module PM constitutes (first) prediction frames each defined from a top field TFi and a bottom field BFi of the interlaced base layer BL that are not associated to a field repeat flag FiRF. So, the processing module PM does not retain the composite prediction frames, and some prediction frames are missing (MPF) into the prediction layer PL.

The second source is the progressive enhancement layer EL. The processing module PM constitutes (second) prediction frames in order to fill up the missing prediction frame MPF into the prediction layer PL under constitution. More precisely, each time it detects a missing prediction frame MPF corresponding to a progressive frame of an enhancement layer EL, it duplicates the progressive frame which precedes this corresponding progressive frame and fill up the corresponding missing prediction frame MPF with the duplicated progressive frame DFr. So, there is no more missing prediction frame MPF into the final prediction layer PL.

In the non-limiting example of FIG. 5, the prediction layer PL comprises the sequence of prediction frames (A1′+A2′, B1′+B2′, Ba, C1′+C2′, D1′+D2′, . . . ). The third prediction frame (Ba) is a duplicate DFr of the second progressive frame (Ba) of the enhancement layer EL, because it corresponds to a duplicated field (B1′) DFi associated with a field repeat flag FiRF.

In this case, the encoding sub-module EM is arranged to encode each progressive frame of the progressive enhancement layer EL because they are all associated with a corresponding prediction frame or duplicated progressive frame DFr. So, it computes the difference between each progressive frame and the corresponding prediction frame or duplicated progressive frame DFr.

In the example illustrated in FIG. 5, the encoding sub-module EM produces an encoded progressive enhancement layer EL′ comprising encoded progressive frames δA′, δBa′, δBb′, δC′ and δD′ resulting from the respective differences (A−(A1′+A2′)), (Ba−(B1′+B2′)), (Bb−Ba), (C−(C1′+C2′)) and (D−(D1′+D2′)).

It is important to notice that the encoding technique implemented by the encoding sub-module EM, according to the third manner (relative to FIG. 5), is identical to the one implemented by a coding device of the prior art, once the prediction layer PL has been constituted. This encoding technique is well known by the man skilled in the art, and it will not be described here.

The encoding sub-module EM outputs a compressed scalable bitstream SVB, comprising the encoded interlaced base layer BL′ and the encoded progressive enhancement layer(s) EL, ready to be transmitted to display devices for instance through a network.

Reference is now made to FIG. 6 to describe an example of embodiment of a decoding device D2 according to the invention, said decoding device being for instance part of an electronic equipment such as a home server, or a set-top-box (especially if it is dedicated to in-home networking), or an interlaced standard definition display set, or a progressive high definition display set.

As schematically and functionally illustrated in FIG. 6, a decoding device D2 according to the invention comprises essentially a decoding module DM for decoding compressed scalable bit-stream SVB generated by a coding device D1. This decoding device receives, as input, at least one encoded interlaced base layer BL′ and at least one encoded progressive enhancement layer EL′.

The decoding module DM comprises a processing module PM′ arranged for constituting a prediction layer PL′ comprising prediction frames defined from the top fields TFi′ and bottom fields BFi′ of the received encoded interlaced base layer BL, and a decoding sub-module SDM to rebuild the progressive frames of each enhancement layer EL″ from the encoded progressive frames of each received encoded progressive enhancement layer EL′, the top fields TFi′ and bottom fields BFi′ of the received encoded interlaced base layer BL and the field repeat flags FiRF that are associated to the first TFi′ and second BFi′ duplicated fields of the interlaced base layer BL′.

More precisely, the decoding sub-module SDM is arranged to compute the sum of each prediction frame and the corresponding encoded progressive frame of each received encoded progressive enhancement layer EL′, while taking into account the field repeat flags FiRF that are associated to the corresponding first TFi′ and second BFi′ duplicated fields of the interlaced base layer BL′.

The field repeat flags FiRF may be used in at least three different manners by the decoding device D2.

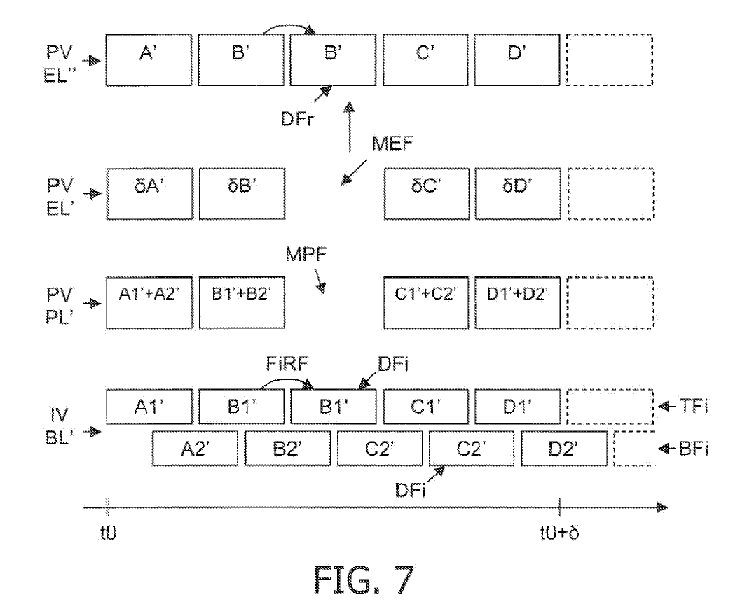

Reference is now made to FIG. 7 to describe a first manner to use the field repeat flags FiRF during decoding, according to the invention. In said first manner, the processing module PM′ is arranged, each time it receives at least an encoded interlaced base layer BL′ associated with at least one encoded progressive enhancement layer EL′, to constitute a prediction layer PL′ which comprises only prediction frames each defined from a top field TFi′ and a bottom field BFi′ of the encoded interlaced base layer BL′ that are not associated to a field repeat flag FiRF. So, the processing module PM′ does not retain the composite prediction frames (previously defined), and some prediction frames are missing (MPF) into the prediction layer PL′ (as illustrated in FIG. 7).

In this case, each received encoded progressive enhancement layer EL′ also comprises missing encoded progressive frames MEF which corresponds to the missing prediction frames MPF of the prediction layer PL′ (as illustrated in FIG. 7), because it has been defined by the coding device D1 according to the first manner.

So, the decoding sub-module SDM is arranged to rebuild each progressive frame of each enhancement layer EL″ by computing the sum of each prediction frame of the prediction layer PL′ and the corresponding (existing) encoded progressive frame, and to fill up each missing rebuilt progressive frame corresponding to first TFi′ and/or second BFi′ field of the interlaced base layer BL′ that is associated to a field repeat flag FiRF, with the duplicate of the preceding rebuilt progressive frame.

In the example illustrated in FIG. 7, the third prediction frame MPF and the corresponding third encoded progressive frame MEF are missing. So, the decoding sub-module SDM firstly rebuilt the progressive frame which corresponds to the existing encoded progressive frames, which gives (A′=(A1′+A2′)+δA′), (B′=(B1′+B2′)+δB′), (C′=(C1′+C2′)+δC′) and (D′=(D1′+D2′)+δD′). Then it duplicates the second rebuilt progressive frame B′ to produce a third rebuilt progressive frame B′. Therefore the final rebuilt progressive enhancement layer EL″ comprises the progressive frame sequence (A′, B′, B′, C′, D′).

It is important to notice that the decoding technique implemented by the decoding sub-module SDM, according to the first manner (relative to FIG. 7), is identical to the one implemented by a decoding device of the prior art, except the part dedicated to the filling up of the missing progressive frames. This decoding technique is well known by the man skilled in the art, and it will not be described here.

The decoding sub-module SDM outputs a decoded scalable bitstream, comprising a decoded interlaced base layer BL and the decoded progressive enhancement layer(s) EL″, ready to be possibly combined to constitute standard or high definition images to display.

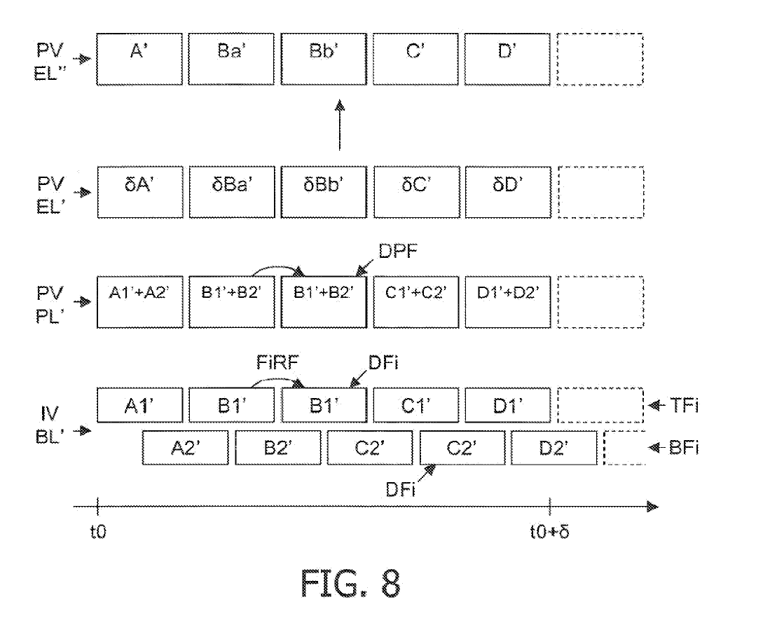

Reference is now made to FIG. 8 to describe a second manner to use the field repeat flags FiRF during decoding, according to the invention. In said second manner, the processing module PM′ is arranged, each time it receives at least an encoded interlaced base layer BL′ associated with at least one encoded progressive enhancement layer EL′, to constitute a prediction layer PL′ which comprises prediction frames each defined from a top field TFi′ and a bottom field BFi′ of the encoded interlaced base layer BL′ that are not associated to a field repeat flag FiRF, and duplicated prediction frames DPF that are respectively identical to the prediction frames which precede them when they correspond to a first TFi′ and/or a second BFi′ field(s) of the encoded interlaced base layer BL′ which is (are) associated to a field repeat flag FiRF. So, there is neither composite prediction frame nor missing prediction frame MPF into the prediction layer PL′.

In the non-limiting example of FIG. 8, the prediction layer PL′ comprises the sequence of prediction frames (A1′+A2′, B1′+B2′, B1′+B2′, C1′+C2′, D1′+D2′, . . . ). The third prediction frame (B1′+B2′) is a duplicate DPF of the second prediction frame (B1′+B2′), because it corresponds to a duplicated field (B1′) DFi associated with a field repeat flag FiRF.

In this case, the decoding sub-module SDM rebuilds each progressive frame of each enhancement layer EL″ by computing the sum of each prediction frame or duplicated prediction frame DPF of the prediction layer PL′ and the corresponding encoded progressive frame of the encoded progressive enhancement layer EL′.

In the example illustrated in FIG. 8, the rebuilt progressive enhancement layer EL″ comprises the progressive frame sequence (A′=(A1′+A2′)+δA′), (Ba′=(B1′+B2′)+δBa′), (Bb′=(B1′+B2′)+δBb′), (C′=(C1′+C2′)+δC′) and (D′=(D1′+D2′)+δD′).

It is important to notice that the decoding technique implemented by the decoding sub-module SDM, according to the second manner (relative to FIG. 8), is identical to the one implemented by a decoding device of the prior art, once the prediction layer PL′ has been constituted. This decoding technique being well known by the man skilled in the art, it will not be described here.

The decoding sub-module SDM outputs a decoded scalable bitstream, comprising the decoded interlaced base layer BL and the decoded progressive enhancement layer(s) EL″, ready to be possibly combined to constitute standard or high definition images to display.

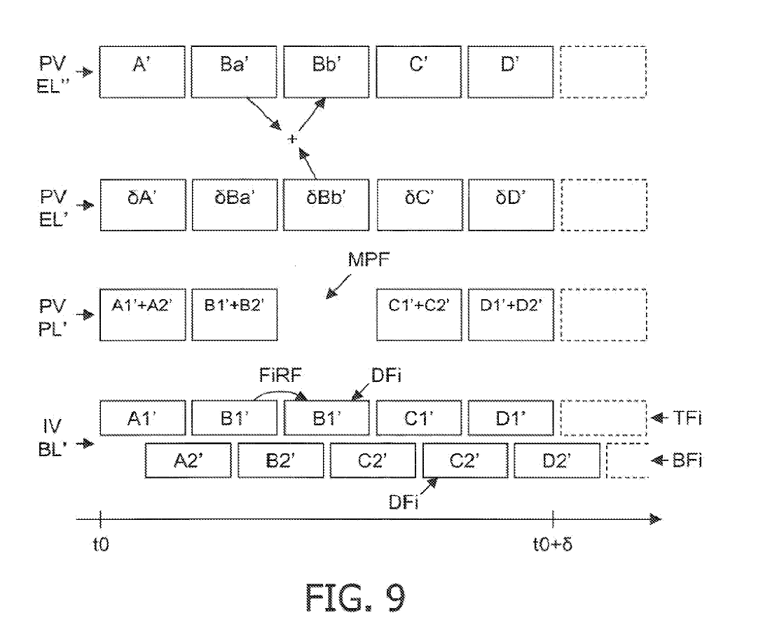

Reference is now made to FIG. 9 to describe a third manner to use the field repeat flags FiRF during decoding, according to the invention. In said third manner, which is a kind of variant of the first manner, the processing module PM′ is arranged, each time it receives at least an encoded interlaced base layer BL′ associated with at least one encoded progressive enhancement layer EL′, to constitute a prediction layer PL′ which comprises only prediction frames each defined from a top field TFi′ and a bottom field BFi′ of the encoded interlaced base layer BL′ that are not associated to a field repeat flag FiRF. So, the processing module PM′ does not retain the composite prediction frames (previously defined), and some prediction frames are missing (MPF) into the prediction layer PL′ (as illustrated in FIG. 9).

In this case, contrary to the first manner, each received encoded progressive enhancement layer EL′ does not comprise missing encoded progressive frames

MEF, because it has been defined by the coding device D1 according to the third manner.

So, the decoding sub-module SDM is arranged to rebuild each progressive frame of each enhancement layer EL″ by computing the sum of each existing prediction frame of the prediction layer PL′ and the corresponding encoded progressive frame, and to fill up each missing rebuilt progressive frame corresponding to a missing prediction frame (and then to first TFi′ and/or second BFi′ field of the interlaced base layer BL′ that is associated to a field repeat flag FiRF), with the sum of the corresponding encoded progressive frame and the duplicate of the rebuilt progressive frame which precedes this progressive frame to rebuild.

In the example illustrated in FIG. 9, the third prediction frame MPF is missing. So, the decoding sub-module SDM firstly rebuilt the progressive frame which corresponds to the prediction frames, which gives (A′=(A1′+A2′)+δA′), (Ba′=(B1′+B2′)+δBa′), . . . , (C′=(C1′+C2′)+δC′) and (D′=(D1′+D2′)+δD′). Then it duplicates the second rebuilt progressive frame Ba′ and adds it to the third encoded progressive frame δBb′ to produce the third rebuilt progressive frame Bb′ (Bb′=Ba′+δBb′). Therefore the final rebuilt progressive enhancement layer EL″ comprises the progressive frame sequence (A′, Ba′, Bb′, C′, D′).

It is important to notice that the decoding technique implemented by the decoding sub-module SDM, according to the third manner (relative to FIG. 9), is identical to the one implemented by a decoding device of the prior art, except the part dedicated to the filling up of the missing progressive frames. This decoding technique is well known by the man skilled in the art, and it will not be described here.

The decoding sub-module SDM outputs a decoded scalable bitstream, comprising the decoded interlaced base layer BL and the decoded progressive enhancement layer(s) EL″, ready to be possibly combined to constitute standard or high definition images to display.

Preferably, the coding device D1 and the decoding device D2 are integrated circuits IC. Such integrated circuits may be realized in CMOS technology or in any technology currently used in chip factory. But, each of them may be also implemented as software, or a combination of hardware and software, in any programmable platform or electronic equipment.

The invention may be also considered as a(n) (en)coding method which can be notably implemented by means of the examples of embodiment of coding device D1 above described. So only the main characteristics of this (en)coding method will be mentioned hereafter.

A(n) (en)coding method according to the invention consists in i) constituting a prediction layer PL comprising prediction frames defined from (first TFi and second BFi) fields of an interlaced base layer BL, and ii) encoding the progressive frames of each progressive enhancement layer EL by computing the difference between each prediction frame and the corresponding progressive frame, while taking into account the field repeat flags FiRF associated to the corresponding duplicated fields of the interlaced base layer BL.

The invention may be also considered as a decoding method which can be notably implemented by means of the examples of embodiment of decoding device D2 above described. So only the main characteristics of this decoding method will be mentioned hereafter.

This decoding method consists in i) constituting a prediction layer PL′ comprising prediction frames defined from pairs of fields (TFi′ and BFi′) of an encoded interlaced base layer BL′, and ii) rebuilding the progressive frames of each enhancement layer EL″ by computing the sum of each prediction frame and the corresponding encoded progressive frame of each encoded progressive enhancement layer while taking into account the field repeat flags FiRF associated to the corresponding duplicated fields of the encoded interlaced base layer BL′.

The invention is not limited to the embodiments of coding device, decoding device, electronic device, coding method and decoding method described above, only as examples, but it encompasses all alternative embodiments which may be considered by one skilled in the art within the scope of the claims hereafter.

There are indeed numerous ways of implementing functions by means of items of hardware or software, or both. In this respect, the drawings are very diagrammatic and represent only possible embodiments of the invention. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description, with reference to the drawings, illustrates rather than limits the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A coding device (D1) comprising coding means (CM) for encoding movie data into a compressed scalable bitstream (SVB), starting from at least one interlaced base layer (BL) comprising interlaced fields, amongst which some are duplicated fields associated to a field repeat flag (FiRF), and at least one progressive enhancement layer (EL) comprising progressive frames, characterized in that said coding means are arranged i) to constitute a prediction layer (PL) comprising prediction frames defined from pairs of fields of said interlaced base layer (BL), except those containing a duplicated field, and ii) to encode said progressive frames of each progressive enhancement layer (EL) by computing the difference between each prediction frame and the corresponding progressive frame, while taking into account the field repeat flags (FiRF) associated to the corresponding duplicated fields of said interlaced base layer (BL) in order to handle each missing prediction frame.

2. A coding device according to claim 1, characterized in that said coding means are arranged i) to constitute a prediction layer (PL) comprising only prediction frames defined from pairs of fields of said interlaced base layer (BL) that are not associated to a field repeat flag (FiRF), and ii) to only encode each progressive frame which corresponds to a prediction frame, by computing the difference between this progressive frame and the corresponding prediction frame.

3. A coding device according to claim 1, characterized in that said coding means are arranged i) to constitute a prediction layer (PL) comprising prediction frames defined from pairs of fields fields of said interlaced base layer (BL) that are not associated to a field repeat flag (FiRF), and duplicated prediction frames each identical to the preceding prediction frame when it corresponds to a field of said interlaced base layer (BL) associated to a field repeat flag (FiRF), and ii) to encode said progressive frames by computing the difference between themselves and the corresponding prediction frames and duplicated prediction frames.

4. A coding device according to claim 1, characterized in that said coding means are arranged i) to constitute a prediction layer (PL) comprising prediction frames defined from pairs of fields of said interlaced base layer (BL) that are not associated to a field repeat flag (FiRF), and for filling up each missing prediction frame corresponding to a field of said interlaced base layer (BL) that is associated to a field repeat flag (FiRF), with the duplicate of the progressive frame which precedes the progressive frame corresponding to this missing prediction frame, and ii) to encode each progressive frame which corresponds to a prediction frame, by computing the difference between this progressive frame and the corresponding prediction frame or duplicate of a progressive frame.

5. A coding device according to claim 1, characterized in that it comprises over-sampling means arranged for over-sampling said fields of said interlaced base layer (BL) before constituting said prediction layer (PL), in order to get a spatial resolution identical to the one of said progressive frames to encode.

6. A coding device according to claim 1, characterized in that it comprises adjustment means (AM) arranged to apply a temporal adjustment technique to primary movie data (PVD) associated to a first frame rate in order to output said interlaced base layer (BL) and said progressive enhancement layer(s) (EL) with a second frame rate adapted to display on a chosen display device.

7. A coding device according to claim 6, characterized in that said adjustment means (AM) are arranged to apply the so-called 3:2 pull-down temporal adjustment technique.

8. A decoding device (D2) comprising decoding means (DM) for decoding a compressed scalable bit-stream, starting from at least one encoded interlaced base layer (BL′) comprising interlaced encoded fields, amongst which some are duplicated fields associated to a field repeat flag (FiRF), and at least one encoded progressive enhancement layer (EL′) comprising encoded progressive frames, characterized in that said decoding means (DM) are arranged i) to constitute a prediction layer (PL′) comprising prediction frames defined from pairs of fields of said encoded interlaced base layer (BL′), and ii) to rebuild said progressive frames of progressive enhancement layer(s) (EL″) by computing the sum of each prediction frame and the corresponding encoded progressive frame of each encoded progressive enhancement layer (EL′), while taking into account said field repeat flags (FiRF) associated to the corresponding duplicated fields of said encoded interlaced base layer (BL′).

9. A decoding device according to claim 8, characterized in that said decoding means (DM) are arranged i) to constitute a prediction layer (PL′) comprising only prediction frames defined from pairs of fields of said encoded interlaced base layer (BL′) that are not associated to a field repeat flag (FiRF), and ii) to rebuild each progressive frame of each progressive enhancement layer (EL″) by computing the sum of each prediction frame and the corresponding encoded progressive frame, and to fill up each missing progressive frame corresponding to a field of said encoded interlaced base layer (BL′) that is associated to a field repeat flag (FiRF), with the duplicate of the preceding rebuilt progressive frame.

10. A decoding device according to claim 8, characterized in that said decoding means (DM) are arranged i) to constitute a prediction layer (PL′) comprising prediction frames defined from pairs of fields of said encoded interlaced base layer (BL′) that are not associated to a field repeat flag (FiRF), and duplicated prediction frames each identical to the preceding prediction frame when it corresponds to a field of said encoded interlaced base layer (BL′) associated to a field repeat flag (FiRF), and ii) to rebuild each progressive frame of each progressive enhancement layer (EL″) by computing the sum of each prediction frame or duplicated prediction frame and the corresponding encoded progressive frame.

11. A decoding device according to claim 8, characterized in that said decoding means (DM) are arranged i) to constitute a prediction layer (PL′) comprising only prediction frames defined from pairs of fields of said encoded interlaced base layer (BL′) that are not associated to a field repeat flag (FiRF), and ii) to rebuild each progressive frame of each progressive enhancement layer (EL″) corresponding to a prediction frame by computing the sum of this prediction frame and the corresponding encoded progressive frame, and to rebuild each progressive frame of each progressive enhancement layer (EL″) corresponding to a missing prediction frame by computing the sum of the corresponding encoded progressive frame and the duplicate of the rebuilt progressive frame which precedes this progressive frame to rebuild.

12. An electronic equipment, characterized in that it comprises a coding device (D1) and/or a decoding device (D2) according to claim 1.

13. An electronic equipment according to claim 12, characterized in that it is chosen in a group comprising at least an home server, a set-top-box dedicated to in-home networking, a broadcasting encoder, a streaming encoder, and a display set.

14. A method of encoding movie data in a compressed scalable bitstream (SVB), starting from at least one interlaced base layer (BL) comprising interlaced fields, amongst which some are duplicated fields associated to a field repeat flag (FiRF), and at least one progressive enhancement layer (EL) comprising progressive frames, characterized in that it comprises the steps of: i) constituting a prediction layer (PL) comprising prediction frames defined from pairs of fields of said interlaced base layer (BL), and ii) encoding said progressive frames of each progressive enhancement layer (EL) by computing the difference between each prediction frame and the corresponding progressive frame, while taking into account the field repeat flags (FiRF) associated to the corresponding duplicated fields of said interlaced base layer (BL).

15. A method of decoding a compressed scalable bitstream, starting from at least one encoded interlaced base layer (BL′) comprising interlaced encoded fields, amongst which some are duplicated fields associated to a field repeat flag (FiRF), and at least one encoded progressive enhancement layer (EL′) comprising encoded progressive frames, characterized in that it comprises the steps of i) constituting a prediction layer (PL′) comprising prediction frames defined from pairs of fields of said encoded interlaced base layer (BL′), and ii) rebuilding the progressive frames of progressive enhancement layer(s) (EL″) by computing the sum of each prediction frame and the corresponding encoded progressive frame of each encoded progressive enhancement layer (EL′), while taking into account said field repeat flags (FiRF) associated to the corresponding duplicated fields of said encoded interlaced base layer (BL′).
